(19) United States
(12) Patent Application Publication
(10) Pub. No.: US 2011/0139914 A1
(43) Pub. Date: Jun. 16, 2011

(54) SHREDDER

(76) Inventors: Mordechai Lev, West Bloomfield, MI (US); Mark Edward Fastabend, Chicago, IL (US); Eric A. Holverson, Naperville, IL (US)

(21) Appl. No.: 13/003,334

(22) PCT Filed: Jul. 7, 2009
(86) PCT No.: PCT/US09/49780

§ 371 Date: Feb. 18, 2011

Related U.S. Application Data
(60) Provisional application No. 61/078,887, filed on Jul. 8, 2008.

(51) Int. Cl. B02C 23/00

(52) U.S. Cl. 241/101.5

(57) ABSTRACT

A shredder is disclosed including a compaction arm coupled to an actuator, wherein the compaction arm includes a cross-member having an array of protuberances formed thereon which facilitate safe and secure destruction of documents.

### CROSS-REFERENCE TO RELATED APPLICATION

This application claims the benefit of U.S. Provisional Patent Application Ser. No. 61/078,887 filed Jul. 8, 2008.

### FIELD OF THE INVENTION

The invention relates to a shredder, and more particularly to a shredder including a compaction feature which facilitates safe and secure destruction of documents.

### BACKGROUND OF THE INVENTION

Because of identity theft, there is heightened awareness among consumers of the importance of protecting sensitive personal information such as credit card bills, tax documents bearing a person's Social Security number, and the like, for example. One such method of protection is to shred materials containing the sensitive personal information. Shredders are well known devices used for shredding materials such as documents, CDs, floppy disks, credit cards, and the like. Typically, shredders contain a series of cutting elements for shredding articles fed therethrough.

There are two basic types of shredders, namely a top-lifting shredder and a drawer-type shredder. The top-lifting shredder has a shredder head mounted atop a container. When the shredder is in operation, a shredded material drops from the shredder head into the container. When the container is substantially full of the shredded material, the shredder head is removed from the container, and the shredded material in the container is discarded. On the other hand, the drawer-type shredder includes a head mounted atop an outer bin. The outer bin includes a pair of sidewalls, a rear wall, and a bottom. A front of the outer bin is an opening for receiving a drawer for the shredded material. When the drawer is full of the shredded material from the operation of the shredder, the drawer is removed from the outer bin and the shredded material is discarded.

The container and the drawer of the shredders have a limited capacity. When the container or the drawer has reached a predetermined fill level, a sensor in the shredder head deactivates cutter elements in the shredder head causing the shredder to be inoperative. A problem with these types of shredders is that the shredded material from the operation of the shredder forms a pile directly underneath the cutter elements of the shredder head. The pile typically reaches the predetermined fill level before the container or the drawer has been filled to a maximum capacity. Another problem is that a space typically forms between each piece of the shredded material as the shredded material collects in the drawer, thereby minimizing a capacity thereof. Furthermore, when the shredder head is removed from the container or when the drawer is removed from the outer bin to discard the shredded material, the cutter elements in the shredder head are exposed. Exposure of the cutter elements may cause injury to fingers and hands of a user.

It would be desirable to produce a shredder which maximizes a capacity thereof and minimizes a risk of injury to the user.

### SUMMARY OF THE INVENTION

In concordance and agreement with the present invention, a shredder which maximizes a capacity thereof and minimizes a risk of injury to the user, has surprisingly been discovered.

In an embodiment, the shredder comprises: a hollow container; and a shredder assembly disposed on the container, the shredder assembly including at least one cutter element adapted to receive a material therein and convert the material to a shredded material for receipt within the container, and a compaction subassembly to compact the shredded material within the container.

In another embodiment, the shredder comprises: a hollow container; and a shredder assembly disposed on the container, the shredder assembly including at least one cutter element adapted to receive a material therein and convert the material to a shredded material for receipt within the container, and a compaction subassembly to compact the shredded material within the container, wherein the compaction subassembly includes a compaction arm disposed within the container and coupled to an actuator.

In another embodiment, the shredder comprises: a hollow container; and a shredder assembly disposed on the container, the shredder assembly including at least one cutter element adapted to receive a material therein and convert the material to a shredded material for receipt within the container, and a compaction subassembly to compact the shredded material within the container, wherein the compaction subassembly includes a compaction arm disposed within the container and coupled to an actuator by at least one linkage and at least one urging mechanism.

### BRIEF DESCRIPTION OF THE DRAWINGS

The invention is explained in more detail in the following with reference to preferred embodiments, given as non-restrictive examples, and explained with reference to the attached schematic drawings in which:

FIG. 1 is a partially exploded perspective view of a shredder according to an embodiment of the invention, wherein a compaction subassembly is in a first position;

FIG. 2 is a bottom perspective view of the shredder illustrated in FIG. 1, wherein a portion thereof is cut away and the compaction subassembly is in a second position;

FIG. 3 is a partially exploded perspective view of the shredder illustrated in FIG. 1, wherein a shredder assembly includes a lid disposed thereon and a compaction subassembly is in a first position; and

FIG. 4 is a partially exploded perspective view of the shredder illustrated in FIG. 3, wherein the compaction subassembly is in a second position.

### DETAILED DESCRIPTION OF EXEMPLARY EMBODIMENTS OF THE INVENTION

The following detailed description and appended drawings describe and illustrate various embodiments of the invention. The description and drawings serve to enable one skilled in the art to make and use the invention, and are not intended to limit the scope of the invention in any manner.

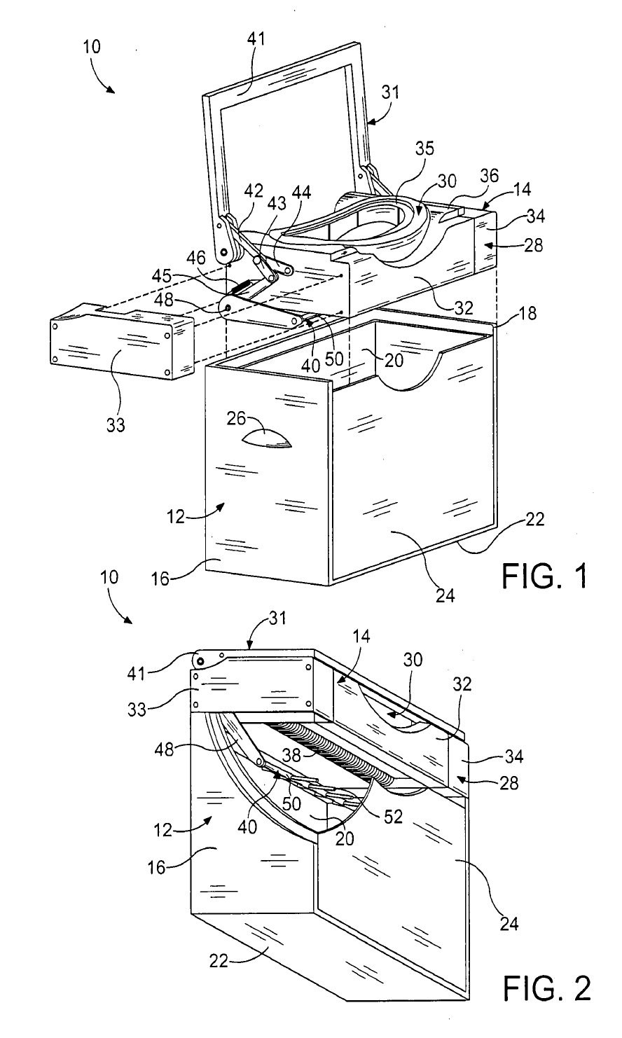

FIGS. 1-4 show a shredder 10 according to an embodiment of the invention. The shredder 10 includes a container 12 and a shredder assembly 14. The container 12 includes a pair of opposed sidewalls 16, 18, a rear wall 20, and a bottom 22. A front of the container 12 is an opening for receiving a drawer 24 therein. The container 12 may include at least one handle 26 to easily transport the shredder 10.

The shredder assembly 14 is disposed on the container 12 to permit shredded materials to fall by gravity into a hollow interior of the drawer 24. A source of electricity (not shown) is typically in communication with the shredder assembly 14 to provide power thereto. A control panel or switch (not shown) controls an operation of the shredder assembly 14. Sensors and other controls can be used as desired to further control operation of the shredder assembly 14. It is understood that the shredder assembly 14 can be used with any container as desired. A gasket (not shown) may be disposed between the shredder assembly 14 and an upper rim of the container 12 to facilitate a sealing therebetween.

The shredder assembly 14 includes a housing 28, a cutter subassembly 30, and a compaction subassembly 31. The housing 28 includes a hollow main body 32 disposed between a first end portion 33 and a second end portion 34. Although the housing 28 shown has a substantially rectangular shape, it is understood that the housing 28 can have any shape and size as desired. The cutter subassembly 30 is disposed in the hollow main body 32 of the housing 28. A mouth 35 of the cutter subassembly 30 is substantially flush with an upper surface 36 of the housing 28. The mouth 35 of the cutter subassembly 30 receives material (not shown) such as paper, credit cards, and the like, for example, therein. At least one cutter element 38 of the cutter subassembly 30 shown in FIG. 2 is coupled to the mouth 35 thereof. It is understood that the cutter element 38 can be any suitable cutter element as desired such as a roller having a series of cutters disposed along a longitudinal axis thereof, for example. The cutter element 38 cuts the material into a shredded material (not shown). The shredded material can be any type of shredded material such as strips and cross cut shreds, for example. It is understood that other types of shredded material can be produced, as desired. In the embodiment shown, the cutter element 38 is in electrical communication with the control panel or switch. The control panel or switch automatically activates the cutter element 38 when the material is received in the mouth 35 of the cutter subassembly 30. It is understood that the cutter subassembly 30 can include other additional components as desired.

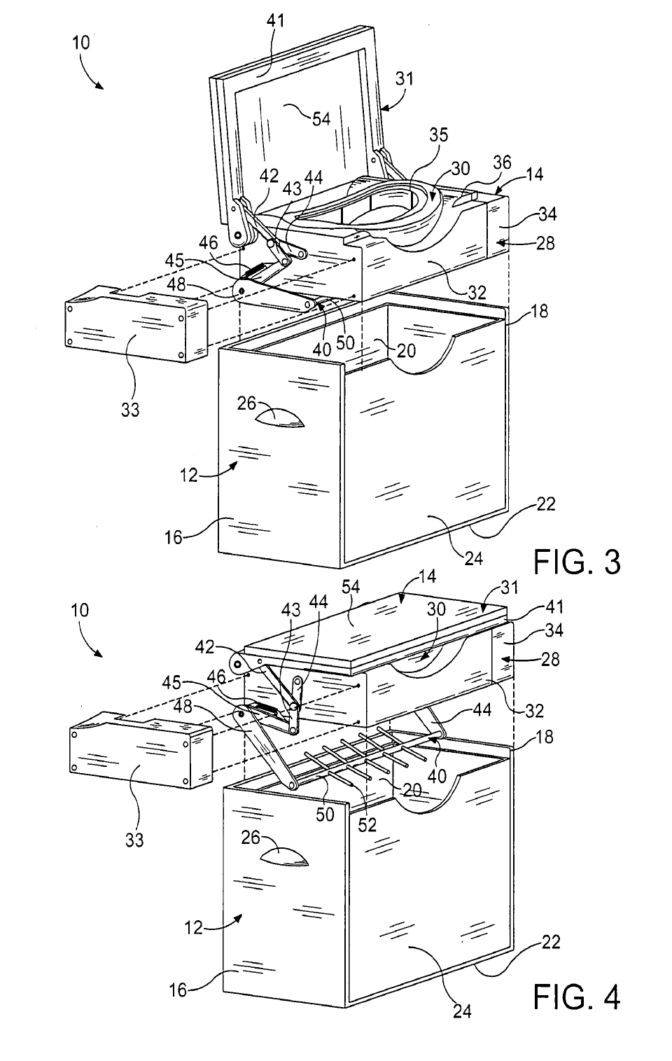

The compaction subassembly 31 is positionable between a first position, as shown in FIGS. 1 and 3, and a second position, as shown in FIGS. 2 and 4. Although the compaction subassembly 31 is substantially mechanically operated, it is understood that the compaction subassembly 31 can be automated if desired. The compaction subassembly 31 includes a compaction arm 40 coupled to an actuator 41. In the embodiment shown, linkages 42, 43, 44, 45 and an urging mechanism 46 operably connect the compaction arm 40 to the actuator 41. It is understood that the compaction arm 40 can be coupled to the actuator 41 by other connecting means as desired. Although the linkages 42, 43, 44, 45 and the urging mechanism 46 shown are disposed between the hollow main body 32 and the first end portion 33 of the housing 28, it is understood that an additional urging mechanism 46 and linkages 42, 43, 44, 45 can be disposed between the hollow main body 32 and the second end portion 34 of the housing 28 as desired. In the embodiment shown, the urging mechanism 45 is an offset torsion spring adapted to cause the compaction arm 40 to retract to the first position and cover the exposed cutter element 38. The urging mechanism 45 is also adapted to limit an amount of force exerted on the compaction arm 40 when the actuator 41 is urged in a first direction and the drawer 24 of the container 12 is at a maximum capacity. Accordingly, when a resistance force of the shredded material is greater than a compression force exerted on the shredded material by the compaction arm 40, the urging mechanism 45 militates against damage to the compression arm 40. It is understood, however, that the urging mechanism 46 can be any suitable urging mechanism as desired.

The compaction arm 40 includes a pair of support members 48 having an elongate cross-member 50 disposed therebetween. Each of the support members 48 is pivotally coupled to the housing 28. As shown, the cross-member 50 includes an array of protuberances 52 extending outwardly therefrom. It is understood that the cross-member 50 can have no protuberances 52 or as many protuberances 52 formed thereon as desired. It is further understood that the cross-member 50 and the protuberances 52 can have any cross-sectional shape as desired such as a circular, a rectangular, and a triangular cross-sectional shape, for example. As shown, the compaction arm 40 is disposed underneath the cutter subassembly 30 laterally offset from the cutter element 38. It is understood, however, that the compaction arm 40 can be disposed underneath the cutter subassembly 30 laterally aligned with the cutter element 38. Lateral alignment of the compaction arm 40 with the cutter element 38, together with a desired cross-sectional shape of the cross-member 50 such as a triangular cross-sectional shape, for example, causes the shredded material to be dispersed throughout the hollow interior of the drawer 24, thereby further maximizing the capacity of the drawer 24. When the compaction subassembly 31 is in the first position, the compaction arm 40 provides a shield for the exposed cutter element 38 to minimize a risk of injury to the user such as when the user removes the drawer 24 from the container 12 to empty the shredded material, for example. When the compaction subassembly 31 is in the second position, at least one of the cross-member 50 and the protuberances 52 compact the shredded material disposed in the drawer 24 of the container 12.

As shown, the actuator 41 is pivotally coupled to the hollow main body 32 of the housing 28. It is understood, however, that the actuator 41 can be disposed elsewhere as desired. Although the actuator 41 shown is a lever, it is understood that the actuator 41 can be any actuator as desired, such as a plunger, a solenoid, and the like, for example. The actuator 41 may also be motor operated and activated electronically as desired such as by a push button disposed on the control panel of the shredder 10, for example.

The shredder assembly 14 may include a lid 54. As shown in FIGS. 3 and 4, the lid 54 is disposed on the actuator 41. It is understood that the lid 54 can be disposed else on the shredder assembly 14 as desired such as pivotally coupled to the housing 28, for example. The lid 54 provides a closure to the mouth 35 of the cutter subassembly 30, thereby militating against inadvertent placement of materials or hands of a user therein. The lid 54 can also be used as a guide for feeding the material into the mouth 35 of the cutter subassembly 30. The lid 54 may include at least one protuberance (not shown) formed thereon to at least one of substantially align the material with the mouth 35 of the cutter subassembly 30 and limit an amount of the material being fed into the cutter subassembly 30. The linkages 43, 44 are pivotally coupled to the linkages 42, 45 at desired positions to permit the lid 54 to remain in a closed position when the resistance force of the shredded material urges the compaction arm 40 from a second position shown in FIGS. 2 and 4.

The compacted material can be recycled or disposed of as desired. The shredder assembly 14 can be provide with a solvent cartridge (not shown) to dispense a solvent or other material to aid in compaction of the material, or to further destroy printed text on the shredded material. The compaction subassembly 31 can also be used in combination with a turbulation feature to further facilitate safe and secure destruction of the material.

In use, the material to be shredded is fed into the mouth 35 of the cutter subassembly 30. It is understood when the lid 54 is disposed on the actuator 41, the compaction subassembly 31 of the shredder assembly 14 is positioned in the first position as shown in FIGS. 1 and 3 prior to the material being fed into the cutter subassembly 30. Thereafter, the cutter element 38 of the cutter subassembly 30 cuts the material into the shredded material. The shredded material is then compacted by urging the actuator 41 in a first direction from the first position to the second position to cause the compaction arm 40 to move from a position proximate the cutter element 38 to a position atop of or in the shredded material. In the embodiment shown, the user downwardly pivots the actuator 41 until the actuator 41 substantially contacts the upper surface 36 of the housing 28. Accordingly, the cross-member 50 and the protuberances 52 of the compaction arm 40 cause the shredded material to be compacted. The cross-member 50 and the protuberances 52 of the compaction arm 40 also disperse the shredded material throughout the hollow interior of the drawer 24. The dispersal of the shredded material militates against re-assembly of the shredded material, thereby maximizing a security of information contained in the shredded material. Furthermore, use of the compaction subassembly 31 optimizes the capacity of the drawer 24 of the shredder 10 by minimizing a space typically formed between each piece of the shredded material. In a non-limiting example, the use of the compaction subassembly 31 illustrated increases the capacity of the drawer 24 by two and a half (2½) times.

If used in combination with a turbulation feature, the shredded material would first be mixed by the turbulation feature, and then compacted by the compression subassembly 31. The mixing of the shredded material separates and mixes shredded material originating from the same material such as a document, for example. The mixing and separation further militates against re-assembly of the shredded material.

Once the drawer 24 of the container 12 is full of the shredded material, the actuator 41 is urged in a second direction causing the compaction arm 40 to move from the position atop of or in the shredded material to the position proximate the cutter element 38. Particularly, the user upwardly pivots the actuator 41. The cross-member 50 and the protuberances 52 provide a shield covering the exposed cutter element 38. Accordingly, the risk of injury to the user removing the drawer 24 to empty the shredded material is minimized. The user transports the shredder 10 by gripping at least one of the walls 16, 18, 20 of the container or the handles 26 formed thereon.

The invention is not limited to the embodiments described and represented in the attached drawings. Modifications are still possible, in particular with regard to the configuration of the various elements or substituting equivalent techniques without departing as such from the scope of protection of the invention.

What is claimed is:

1. A shredder comprising:
a hollow container; and
a shredder assembly disposed on the container, the shredder assembly including at least one cutter element adapted to receive a material therein and convert the material to a shredded material for receipt within the container, and a compaction subassembly to compact the shredded material within the container.

2. The shredder according to claim 1, wherein the compaction subassembly includes a compaction arm coupled to an actuator.

3. The shredder according to claim 1, wherein the compaction subassembly provides a shield for the at least one cutter element.

4. The shredder according to claim 1, wherein the compaction subassembly includes a compaction arm laterally offset from the at least one cutter element.

5. The shredder according to claim 1, wherein the shredder assembly includes a lid disposed thereon to provide a closure thereto.

6. A shredder comprising:
a hollow container; and
a shredder assembly disposed on the container, the shredder assembly including at least one cutter element adapted to receive a material therein and convert the material to a shredded material for receipt within the container, and a compaction subassembly to compact the shredded material within the container, wherein the compaction subassembly includes a compaction arm disposed within the container and coupled to an actuator.

7. The shredder according to claim 6, wherein the compaction arm provides a shield for the at least one cutter element.

8. The shredder according to claim 6, wherein the compaction arm is laterally offset from the at least one cutter element.

9. The shredder according to claim 6, wherein the compaction arm includes a cross-member having an array of protuberances formed thereon.

10. The shredder according to claim 6, wherein the compaction arm is coupled to the actuator by at least one linkage and at least one urging mechanism.

11. The shredder according to claim 6, wherein the shredder assembly includes a lid disposed thereon to provide a closure thereto.

12. The shredder according to claim 6, wherein the actuator is pivotally disposed on a housing of the shredder assembly.

13. A shredder comprising:
a hollow container; and
a shredder assembly disposed on the container, the shredder assembly including at least one cutter element adapted to receive a material therein and convert the material to a shredded material for receipt within the container, and a compaction subassembly to compact the shredded material within the container, wherein the compaction subassembly includes a compaction arm disposed within the container and coupled to an actuator by at least one linkage and at least one urging mechanism.

14. The shredder according to claim 14, wherein the compaction arm provides a shield for the at least one cutter element.

15. The shredder according to claim 14, wherein the compaction arm is laterally offset from the at least one cutter element.

16. The shredder according to claim 14, wherein the compaction arm includes a cross-member having an array of protuberances formed thereon.

17. The shredder according to claim 14, wherein the shredder assembly includes a lid disposed thereon to provide a closure thereto.

18. The shredder according to claim 14, wherein the actuator is adapted to cause the compaction arm to be positioned in a first position and a second position.

19. The shredder according to claim 18, wherein the at least one linkage is adapted to permit a lid disposed on the shredder assembly to remain in a closed position when a resistance force of the shredded material urges the compaction arm from the second position.

20. The shredder according to claim 14, wherein the urging mechanism is adapted to limit an amount of force exerted on the compaction arm when the actuator is urged in a first direction and a drawer of the container is at a maximum capacity.
